(19) United States
(12) Patent Application Publication
(10) Pub. No.: US 2026/0023522 A1
(43) Pub. Date: Jan. 22, 2026

(54) CONTEXT AWARE AUDIO DATA AQUISITION

(71) Applicant: Adobe Inc., San Jose, CA (US)

(72) Inventors: Chang Xiao, Sunnyvale, CA (US); Xia Su, Seattle, WA (US); Eunyee Koh, San Jose, CA (US)

(73) Assignee: Adobe Inc., San Jose, CA (US)

(21) Appl. No.: 18/777,231

(22) Filed: Jul. 18, 2024

(51) Int. Cl. G06F 3/16; G06F 3/04815; G06F 3/0484; G06F 40/186; G06F 40/40; G06V 20/40

(52) U.S. Cl. CPC G06F 3/165; G06F 3/04815; G06F 3/0484; G06F 40/186; G06F 40/40; G06V 20/44

(57) ABSTRACT

Context aware audio data acquisition techniques are described. In one or more examples, an event is detected from one or more inputs defining interaction of a virtual object in a user interface with a depiction of a real-world physical environment captured by frames of a digital video. A context of the event in the user interface is monitored and used to generate a prompt to initiate acquisition of audio data based on the context using one or more machine-learning models. The audio data generated by the one or more machine-learning models is presented for output via the user interface.

### BACKGROUND

Audio plays a central role in a user's experience as part of consuming digital content, examples of which include digital videos, animations, video games, slideshows, presentations, audio books, and so forth. Audio, for instance, is usable to implement sound effects to enhance realism in a scene depicted by the digital content.

Conventional techniques utilized to employ audio as part of digital content, however, rely on manual selection of audio, which is time consuming and computationally resource intensive and expensive. Conventional techniques are further challenged when confronted with the billions of potential uses for audio as part of digital content, therefore involving manual navigation through an even greater number of options to select audio of interest.

### SUMMARY

Content aware audio data acquisition techniques are described that address these and other technical challenges. An audio generation system, for instance, is configurable to employ a machine-learning based audio authoring system. The audio generation system is configured to acquire audio data, automatically and without user intervention, based on a context that is monitored for an interaction that is to serve as a basis for generating the audio data, e.g., as a sound effect.

The audio generation system, in one or more examples, is configurable to implement a programming by demonstration (PbD) pipeline to automatically collect a context as contextual information of an event, which may include virtual content semantics, real world context, and so forth. Data detailing this context is then processed by a machine-learning system (e.g., large language model) to acquire audio data, which may include selection by the large language model of a technique from a plurality of techniques usable to generate the audio data. User interface techniques are also employed that support digital content creation using the generated audio data.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures Entities represented in the figures are indicative of one or more entities and thus reference is made interchangeably to single or plural forms of the entities in the discussion.

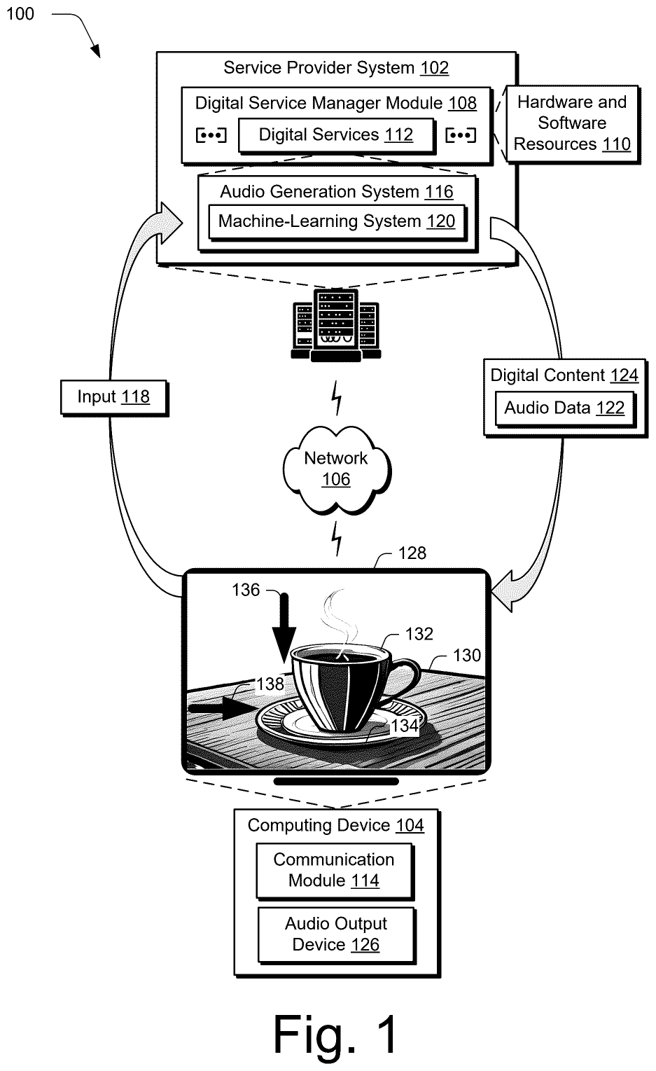

FIG. 1 is an illustration of a digital medium environment in an example implementation that is operable to employ content aware audio data acquisition techniques described herein.

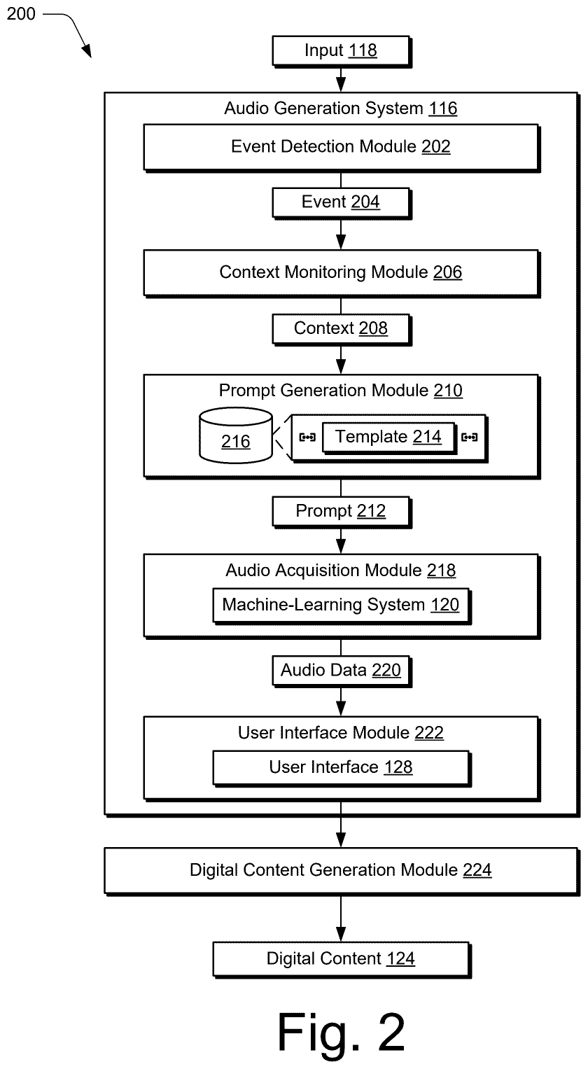

FIG. 2 depicts a system in an example implementation showing operation of an audio generation system of FIG. 1 in greater detail as acquiring audio data as part of digital content based on an input and context.

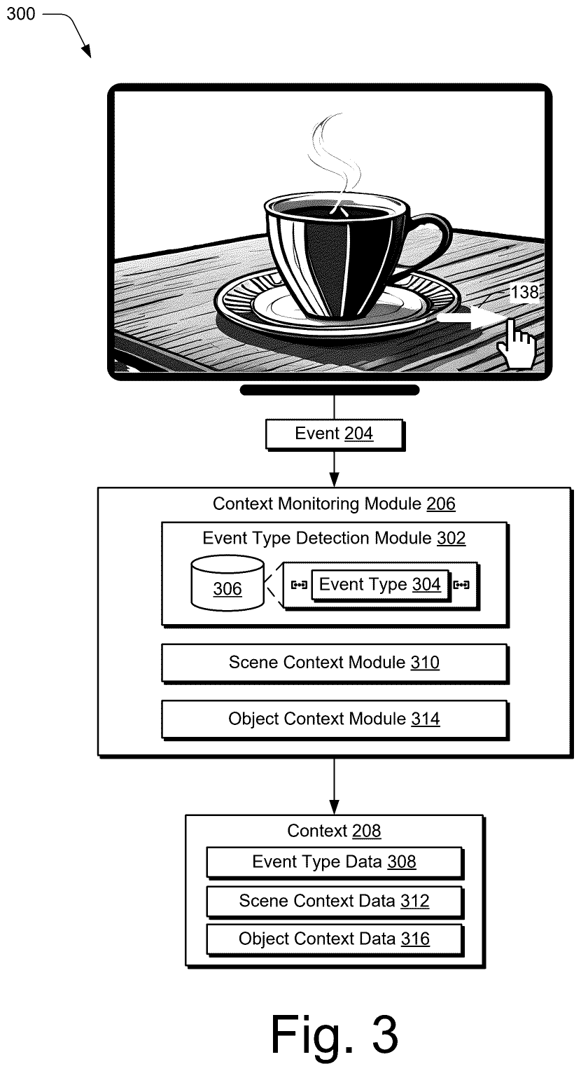

FIG. 3 depicts a system in an example implementation showing operation of a context monitoring module of FIG. 2 in greater detail as monitoring a context of an event.

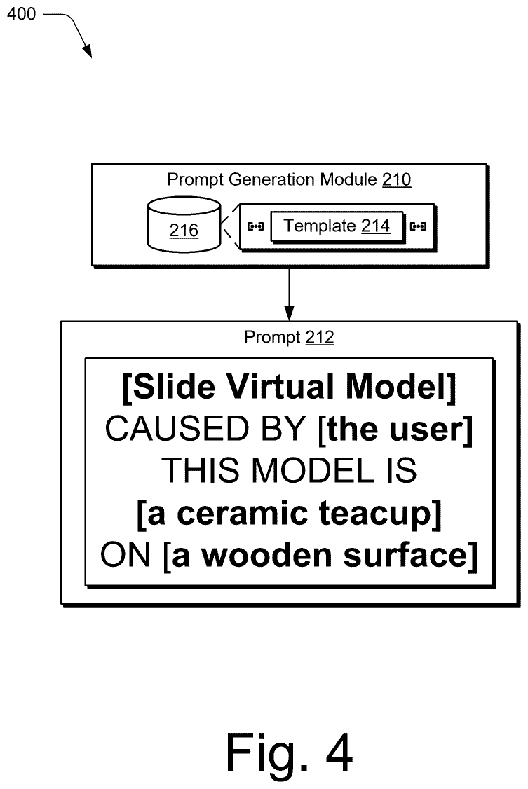

FIG. 4 depicts a system in an example implementation showing operation of a prompt generation module of FIG. 2 in greater detail as generating a prompt based on a context of an event.

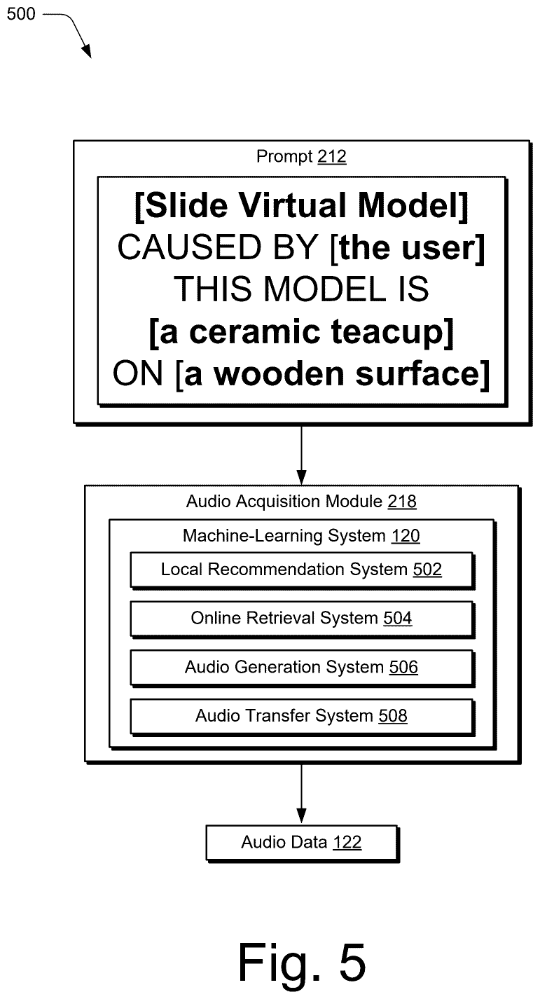

FIG. 5 depicts a system in an example implementation showing operation of an audio acquisition module of FIG. 2 in greater detail as obtaining audio data based on a prompt of FIG. 4.

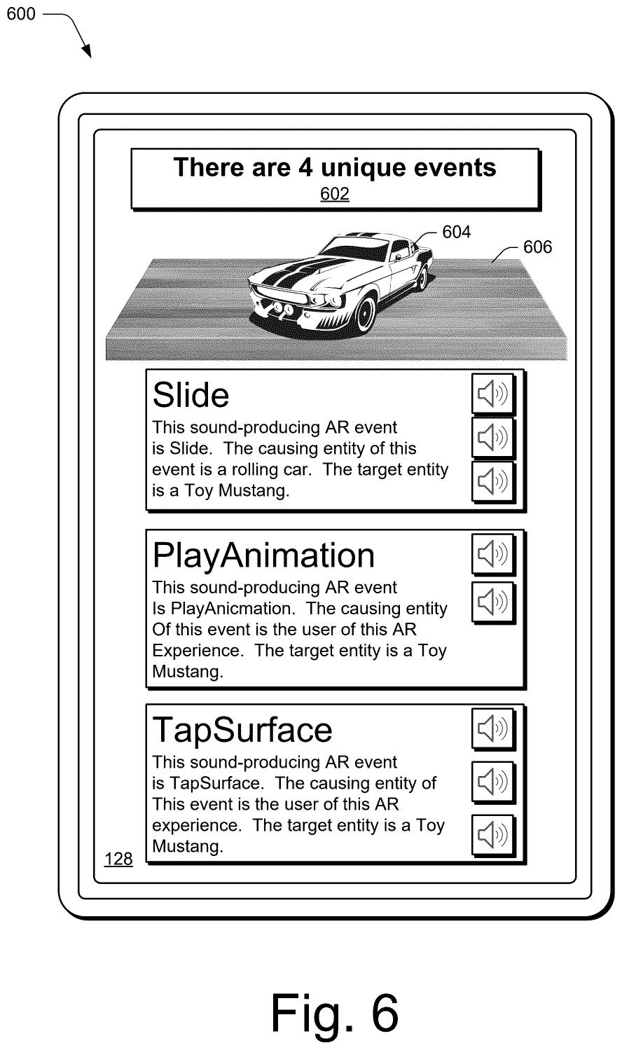

FIG. 6 depicts a system in an example implementation showing output of a user interface of FIG. 2 in greater detail of the audio data generated using the one or more machine-learning models of FIG. 5.

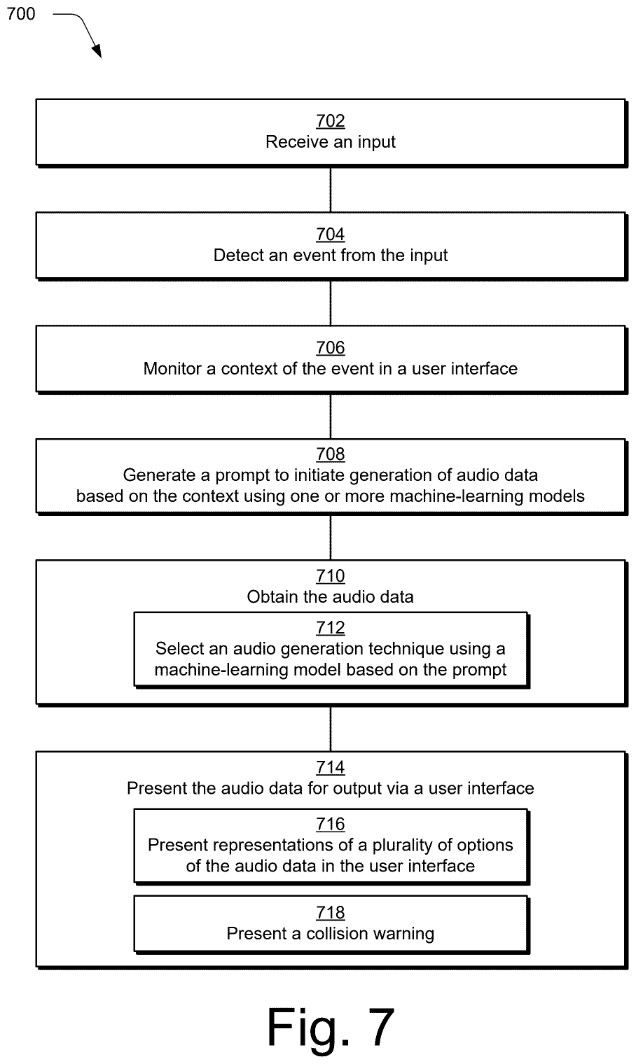

FIG. 7 is a flow diagram depicting an algorithm as a step-by-step procedure in an example implementation of operations performable for accomplishing a result of context aware audio data generation.

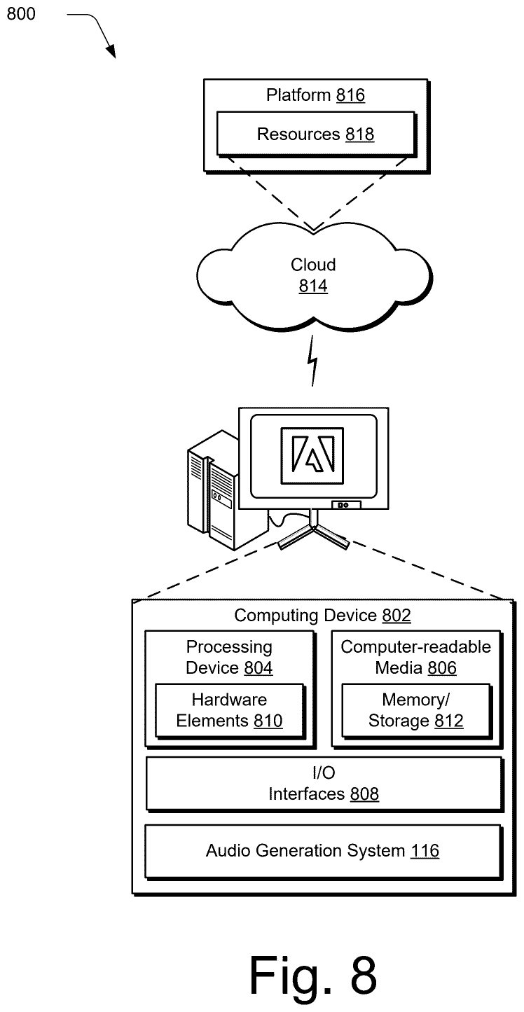

FIG. 8 illustrates an example system including various components of an example device that can be implemented as any type of computing device as described and/or utilize with reference to the previous figures to implement embodiments of the techniques described herein.

### DETAILED DESCRIPTION

### Overview

Audio plays a central role in a variety of types of digital content in support of a multitude of user experiences. An example of which includes extended reality (XR), which includes augmented reality (AR) in which virtual objects interact with a depiction of a real-world environment and virtual reality (VR) which involves virtual object interaction in a virtual environment. Conventional techniques used to add audio (e.g., to include sound effects in an augmented reality scenario), however, typically rely on manual selection of the audio.

A creative, for instance, when confronted with adding a virtual object to a depiction of a real-world environment in a user interface is tasked with understanding an interaction of a subject with an object, material properties of each object, an understanding of the environment surrounding the objects, and then locating audio based on these criteria. Thus, even in a simple example the creative is tasked with locating a desired sound effect from a multitude of options. Further, navigation through the multitude of options may also involve manually consuming (i.e., listening to) each of the options individually due to the nature of audio, e.g., audio does not support ready consumption of multiple items at a single time as a simple glance which is available for digital images.

Accordingly, content aware audio data acquisition techniques are described that address these and other technical challenges. An audio generation system, for instance, is configurable to employ a large language model (LLM) based audio authoring system. The audio generation system is configured to acquire audio data, automatically and without user intervention, based on a context that is monitored for an interaction that is to serve as a basis for generating the audio data, e.g., as a sound effect. The audio generation system, in one or more examples, is configurable to implement a programming by demonstration (PbD) pipeline to automatically collect a context as contextual information of an event, which may include virtual content semantics, real world context, and so forth. Data detailing this context is then processed by a large language model to acquire audio data.

To do so, the audio generation system may employ a variety of audio acquisition techniques, examples of which include local recommendation, online retrieval, audio generation using an audio diffusion model, and audio transfer using text-based sound style transfer. Audio data generated by the audio generation system is usable to support a variety of usage scenarios, examples of which include user safety, assistive techniques (e.g., for low vision AR users), animation generation, digital content creation, and so forth.

In one or more examples, an input is received by an audio generation system. The input, for instance, may involve a gesture detected via a user interface as part of an augmented reality environment that includes a depiction of a real-world environment having a physical object (e.g., a table) with a virtual object of a robot. The gesture in this instance is configured to cause the robot to appear to walk across the table.

In response, the audio generation system detects an event and monitors a context of the event. The context may include a context type of “walking virtual model,” a subject of “the user” and an object of “robot.” The context is then used by the audio generation system to generate a prompt. The audio generation system, for instance, “fills in” a template to recite text of “[walking virtual model] caused by [the user] and the model is [a toy robot] on [a wooden surface].”

The prompt is then processed by one or more machine-learning models (e.g., using generative artificial intelligence) to generate the audio data. The audio generation system, for instance, is configurable to utilize local recommendation, online retrieval, audio generation using an audio diffusion model, audio transfer using text-based sound style transfer, and so on to acquire the audio data. The audio data is then presented for output in a user interface, e.g., to generate sound by an audio output device, display as a spectrogram, and so forth.

The audio generation system is also configurable to support user interaction in selecting from a plurality of options of audio data. A user interface, for example, is configurable to indicate respective events and provide options for audio data (e.g., sound effects) for each of those events. In the robot example above, events may include footfalls of the robot on the wooden surface, movement of the robot's arms, creaking of the robot's joints, and so forth.

The user interface may then describe the event and representations of options for audio data usable for output in conjunction with a respective event. Selection of the options, for instance, causes output of respective audio data that may then be assigned to the event. Once assigned, digital content may then be created, e.g., as an animation, as a digital video, assigned for use with the virtual object in the future, and so forth. A variety of other examples are also contemplated, including user safety, assistive techniques, and so forth. In this way, the context aware audio data generation techniques described herein address conventional technical challenges with increased user and computational efficiency. Further discussion of these and other examples is included in the following discussion and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “diffusion model” is a type of generative machine-learning model that is used for digital content creation, e.g., digital images, digital audio, and so forth. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Audio Acquisition Environment

FIG. 1 is an illustration of a digital medium environment 100 in an example implementation that is operable to employ content aware audio data acquisition techniques described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 8.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement an audio generation system 116, although implementation of the audio generation system 116 locally by the computing device 104 is also supported. The audio generation system 116 is configured to receive an input 118 and process the input by a machine-learning system 120 to generate audio data 122 (e.g., using generative AI) as part of digital content 124.

In the illustrated user interface 128, for instance, a digital image includes a coffee table 130 captured using a digital camera of the computing device 104 from a real-world environment, e.g., as a frame as part of a livestream. A first virtual object as a ceramic teacup 132 and a second virtual object of a ceramic saucer 134 are also included in the user interface 128. A variety of events are supported in the illustrated user interface 128, e.g., a first event 136 to set the ceramic teacup 132 on the ceramic saucer 134, a second event 138 to slide the ceramic saucer 134 across a surface of the coffee table 130, and so forth. Accordingly, each of these events may involve a variety of differences that are captured as context that is usable by the machine-learning system 120 to generate the audio data 122.

The audio generation system 116 is configured to leverage context to express these differences as part of generating the audio data 122, e.g., as a text-to-audio diffusion model implemented by the machine-learning system 120. The audio generation system 116 is configurable to adopt a programming by demonstration (PbD) pipeline to simplify a description of complex interactions. The PbD pipeline, for instance, enables user demonstration of XR sound interactions while the audio generation system 116 automatically detects events and collects context information about the events. For example, if a creator wants initiate generation of audio data 122 by the audio generation system 116 of the stomping of a walking robot, the virtual robot may be positioned on a target (e.g., depiction of a physical or real world) surface. As the robot walks, a collision between robot's feet and the surface, as well as the context information like the robot's attributes and the surface's material, is captured by the audio generation system 116 for use in generating the audio data 122.

In an implementation, in order to utilize XR context information originating from multiple sources (e.g., user action, virtual object, real world environment) and in different formats (e.g., categorical, 3D shape, image), text is used as a universal medium to encompass the context information. The context, for instance, may be expressed using with text by fitting different parts into a template, e.g., “This event is [Event Type], caused by [Source] to [Object],” “This event casts on [Target Object] and [Additional Information on Involved Entities] by [Source],” and so on.

Additionally, the audio generation system 116 is configurable to employ LLM-based sound acquisition. The audio generation system 116, for instance, leverages a suite of four audio acquisition techniques (e.g., recommend, retrieve, generate, and transfer) that are controlled by an underlying LLM of the machine-learning system 120. For each event, the context as text is fed to the LLM for processing. The LLM then provides text prompts that control the suite of four audio acquisition techniques, which automatically provide corresponding audio data 122 assets for event.

To author audio data 122 for an XR scenario, for instance, an input 118 is received of an event involving an interaction with an object via the illustrated user interface 128. In response, the audio generation system 116 automatically lists sound options based on context. For example, in order to make the virtual teacup 132 chime crisply when being placed on the ceramic saucer 134. In conventional approaches, the creator would manually specify this action and find a sound asset to match the chiming ceramic teacup. But with the audio generation system 116, on the other hand, the creator demonstrates this event and the chime sounds are generated automatically, e.g., as options that are selectable by the creator. Further discussion of these and other examples are included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Context Aware Audio Data Acquisition

The following discussion describes audio data acquisition techniques that are context aware and implementable utilizing the described systems and devices.

Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 7 is a flow diagram depicting an algorithm 700 as a step-by-step procedure in an example implementation of operations performable for accomplishing a result of context aware audio data generation. In portions of the following discussion, reference is made interchangeably with the algorithm 700 of FIG. 7.

FIG. 2 depicts a system 200 in an example implementation showing operation of the audio generation system 116 of FIG. 1 in greater detail as generating audio data as part of digital content based on an input and context. The audio generation system 116 in this example implements an audio data design space that is configurable to emphasize a sonic interplay between three factors of XR experiences: (1) reality, denoting the physical environment in the real world that hosts the XR experience; (2) virtuality, referring to the virtual object(s) placed in the XR experience; and (3) the user, representing an entity interacting with the XR experience. Other types of digital content are also contemplated as further described below.

“Virtuality” refers to audio that accompanies events involving solely virtual objects. Virtuality may be bound to an object's change of status (e.g., a notifying sound when a virtual object “shows up”), from an object's animated behavior (e.g., a mechanical noise made by a virtual dinosaur roaring), the interaction between multiple virtual objects (e.g., two virtual balls clacking during a collision), and so forth. Although conventional authoring tools may support status change and animation as sound-initiating triggers, conventional authoring tools do not support sound for interactions between virtual objects.

“User/virtuality” involves audio data related to user actions with virtual objects, e.g., a tap on a virtual surface. User/reality refers to audio data that is configured to accompany user interactions with a depiction of a physical environment in a user interface. The audio data, for instance, is configurable to provide feedback to improve a user's understanding of a surrounding environment as captured in a user interface.

“Virtuality/reality” denotes audio data as feedback to enhance realism when virtual objects interact with a depiction of a real-world environment, e.g. the crisp stomping sound of a virtual robot when it walks on a real-world glass surface. “User/virtuality/reality” refers to audio data that is configured to accompany user actions involving both virtual and real elements. For example, the material-aware sliding sounds when a virtual scraper is applied on different real-world surfaces, e.g., wooden table, painted wall, or glass window.

Accordingly, the audio generation system 116 is configured to support an authoring framework that leverages context recognition and generative AI to create personalized, context-sensitive audio data 122. To do so, the audio generation system 116 employs event textualization in which inputs 118 involving user interactions are detected as an event, and a context of these events is transformed into textual descriptions. The audio generation system 116 is also configured to support audio acquisition through an LLM-controlled acquisition process that utilize a variety of techniques to produce the audio data 122 based on the context. The audio generation system 116 also supports a user interface that allows users to experience an XR scene and provides the capability to view, modify, and test audio data 122 (e.g., as sound effects) for the events.

To begin in this example, an input 118 is received (block 702) by the audio generation system 116. The input 118, for instance, may be received via the user interface 128 as involving user interaction with a virtual object, e.g., via a gesture, touchscreen functionality, a spoken utterance, through use of a cursor control device, keyboard, and so forth.

An event detection module 202 is then employed to detect an event 204 from the input 118. The event 204 defines interaction of a virtual object in a user interface 126 with a depiction of a real-world physical environment captured by frames of a digital video (block 704), e.g., using a digital camera of the service provider system 102. Other examples are also contemplated as previously described, e.g., for solely virtual.

The digital video, for instance, is configurable as a “live stream” of digital images as frames that capture depictions of physical objects in the real-world physical environment. The event detection module 202, for instance, is configurable to recognize (e.g., using image processing) user interactions with virtual of physical objects, interactions of virtual objects with depictions of physical objects, interactions of depictions of physical objects with each other, and so forth. In an implementation each of the interactions is used to initiate a corresponding event

In response to detecting the event, a context monitoring module 206 is employed to monitor a context 208 of the event (block 706). In order to combine generation and retrieval techniques as part of audio acquisition, one challenge is how to condition this suite of different sound acquisition techniques. Accordingly, in one or more implementation text is used as a universal representation for context audio data acquisition, which supports a variety of technical advantages.

First, text can sufficiently and precisely convey context information and the specifics of audio data generation events, e.g., a “user slides a ceramic cup on a wooden surface.” Second, given that an XR experience operates within a hardware-software system with multi-modal sensors (e.g., camera, inertia measurement unit, GPS, positional sensors) of the computing device 104, this hardware-software system may be leveraged to monitor and collect data describing a context within the XR experience and summarize this data into descriptive text. Third, machine-learning models (e.g., LLMs) may be employed as a controller to process text for audio data generation.

FIG. 3 depicts a system 300 in an example implementation showing operation of the context monitoring module 206 of FIG. 2 in greater detail as monitoring a context 208 of an event 204. The context monitoring module 206, for instance, is illustrated as monitoring context of the second event 138 of FIG. 1 involving selection of a virtual object for movement on a surface of a depiction of a physical object, e.g., in a real-world environment.

The context monitoring module 206 is implemented as part of a PbD authoring framework to capture context of potential events as text. When user interactions are detected, for instance, the audio generation system 116 and particularly the event detection module 202 and context monitoring module 206 detect and monitor events that can lead to sound feedback. In these examples, an event 204 is defined as a user action and a subsequent result, e.g. when a user taps a virtual object to trigger its animation.

The context monitoring module 206 is configured to employ a variety of functionalities to monitor a context 208. Examples of these functionalities include an event type detection module 302 that is configured to monitor an event type 304 (e.g., illustrated as stored in a storage device 306) for inclusion as event type data 308 as part of the context 208. A scene context module 310 is configured to generate scene context data 312, e.g., describing an environment, in which, the event 204 occurs whether virtual or a depiction of a real-world environment. An object context module 314 is configured to monitor objects as part of providing object context data 316 describing one or more objects involved in the event.

For an XR event, the context 208 may include an event type (e.g. tapping an object), action source (e.g. user or virtual object), and action target, e.g. virtual object or real-world plane. Information about the involved entities, such as virtual objects or real-world planes, is also includable as part of the context 208. An event type 304 is configured to define a range of interactions as part of an event. Examples of event types include a tap on a virtual object depicted in the user interface, movement of a virtual object on a surface, a collision between a virtual object and another object, an animation of a virtual object, appearance of a virtual object in a user interface, and so forth.

The scene context module 310 is configured to assess a surrounding environment involved in the event 204, e.g., through use of plane detection functionality. A deep material segmentation machine-learning model, for instance, may be utilized to segment a depicted scene and identify material of planes in the scene. In XR scenarios, this functionality supports production of realistic audio data (e.g., sound effects) when an XR event involves a plane. Examples of materials include wood, carpet, concrete, paper, metal, glass, and so forth.

The object context module 314 is configurable to monitor semantics of virtual objects as well as depictions of physical objects as described above. In virtual object understating, semantics of virtual objects are determined to ensure that audio data is generated that aligns with the virtual object's material, state, and so forth. The object context module 314, for instance, is configured to obtain a text description for a virtual object (e.g., “This model is a toy robot made of metal”), corresponding animations (e.g., “A toy robot walks”), and so on. These descriptions may be output in a user interface in support of additional edits, clarifications, or calculation of other relevant details.

Returning again to FIG. 2, the event 204 and the context 208 are then passed as an input to a prompt generation module 210 to generate a prompt 212. The prompt 212 is configured to initiate generation of audio data 122 based on the context using one or more machine-learning models (block 708). The prompt generation module 210 is configured to do so in a variety of ways, including use of one or more templates 214 (illustrated as stored in a storage device 216) that are “filled in” by the prompt generation module 210, e.g., using natural language processing. An example of which is described below and shown in a corresponding figure.

FIG. 4 depicts a system 400 in an example implementation showing operation of a prompt generation module 210 of FIG. 2 in greater detail as generating a prompt 212 based on a context 208 of an event 204. In order to aggregate the multi-source context information described above, a template 214 configured to employ text is used. In the illustrated example, text of the prompt is illustrated in all caps and text taken from the context and the event are illustrated as within brackets. The prompt 212, for instance, is depicted as “[slide virtual model] CAUSED BY [the user], THIS MODEL IS [a ceramic teacup] ON [a wooden surface].

The template 214 is also configurable in a variety of other ways. In another example, the template 214 specifies “THIS EVENT IS [event type], CAUSED BY [source]. THIS EVENT CASTS ON [target object]. [Additional information on involved entities].” Event type is a type of event as described by the type name as described above, e.g., “slide virtual model.” A source refers to a subject of the event, which could be the user when the event is directly triggered by user, a virtual object when it interacts with real-world environment, and so forth. A target object (also referred to simply as “object”) is an object of the event, e.g., a plane that is tapped, an animation that is played, and so forth. “Additional information on involved entities” includes details that further elucidate the source object, the triggered event, and the target object, such as material descriptions and animation details. During monitoring of user interactions as part of the event, the context monitoring module 206 logs text describing the events which is then used to “fill in” the template 214 to form the prompt 212 by the prompted generation module 210.

The prompt 212 is provided to an audio acquisition module 218 which is used to obtain audio data 220 by the one or more machine-learning models (block 710), e.g., by a machine-learning system 120. In an implementation, an audio generation technique is selected using a machine-learning model based on the prompt 212 (block 712), an example of which is further described below.

FIG. 5 depicts a system 500 in an example implementation showing operation of an audio acquisition module 218 of FIG. 2 in greater detail as acquiring audio data 122 based on the prompt 212 of FIG. 4. The machine-learning system 120 is configured to acquire the audio data 122 from a variety of sources, examples of which include a local recommendation system 502, an online retrieval system 504, an audio generation system 506, and an audio transfer system 508. This functionality is configurable to optimize use of computational resources in obtaining the audio data 122.

For example, a mechanical noise of a virtual robot (i.e., “virtuality”) may be readily sourced from local or online sound databases by the local recommendation system 502. However, more specific sounds, like a virtual steel ball hitting a physical concrete wall surface or a virtual racecar jumping into a backyard pool (i.e., “virtuality/reality”) involves physical world understanding and material awareness with the space of possible sound effects being near infinite. Thus, in such scenarios, generating sounds using text-to-sound models is employed using an audio generation system 506, e.g., using an audio diffusion model.

Therefore, the audio acquisition module 218 in this example employs a machine-learning model (e.g., LLM) to automatically retrieve or generate context-matching sound assets of an event. The machine-learning model, for instance, is usable as a controller for use of multiple sound authoring techniques. The LLM takes the text description of the event from the prompt 212 as input and replies with commands for multiple sound acquisition techniques as represented by the audio acquisition module 218.

The local recommendation system 502, for instance, is chosen by the LLM to recommend sound assets stored in the local database based on semantics in the event description. A set of sound effects, for instance, are collected with each labeled with a descriptive file name, e.g., “Crash Aluminum Tray Bang” or “Liquid Mud Suction.” The list of file names is provided to LLM and therefore, when provided with the context as specified by the prompt 212, the LLM recommends a threshold number (e.g., a top five) items of audio data (e.g., sound effects) based on the respective file names.

The local recommendation system 502 then returns the selected sound effect in this example in a recommended format. Upon receipt, the audio acquisition module 218 parses the filename and adds a threshold number of corresponding items of audio data as options for the event in a user interface as further described below.

The online retrieval system 504 is configurable to expand a retrieval capability to include an online sound asset database via a respective application programming interface (API). The API, for instance, returns a list of items of audio data based on a given query as expressed by the prompt 212. The queries, in one or more examples, are condensed versions of full event descriptions generated by the LLM. The returned results are configurable as JavaScript Object Notation (JSON) strings containing information from the search results. The online retrieval system 504 selects a threshold number of items from the search result, which may then be downloaded and presented in a user interface.

The audio generation system 506 is configured to interact with an audio diffusion model to generate the audio data 122 based on the prompt 212. The LLM, for instance, is tasked by the audio generation system 506 to compress the event text description from the prompt 212 into a shortened generation prompt. Upon receiving such a command from the LLM by the audio generation system 506, the prompt is sent by the audio generation system 506 to an audio diffusion model to initiate text-to-sound generation.

The audio transfer system 508 is configured to implement text-based sound style transfer as part of the audio acquisition module 218. For events like “tapping,” “sliding,” or “colliding,” for instance, instead of generating audio data “from scratch”, the audio transfer system 508 employs default audio data and initiates a style transfer operation with a text prompt provided by the LLM. This approach allows the output audio data to match a length and rhythm of the input audio data for coordination with the event. Furthermore, the audio transfer system 508 supports a text-based style transfer as a fine-tuning and customization option based on user inputs.

The audio data obtained by the one or more machine-learning models is presented for output via the user interface (block 714) by the audio acquisition module 218. The output, for instance, may include presenting representations of a plurality of options of the audio data in the user interface 128 (block 716) by a user interface module 222. In another example, a collision warning is presented (block 718) by the user interface module 222, e.g., to provide a warning of potential impact in a real world environment. The audio data 220 may also be leveraged by a digital content generation module 224 to generate digital content 124 that includes the audio data 220, e.g., an animation, digital video, author an XR environment, and so forth.

FIG. 6 depicts a system 600 in an example implementation showing output of a user interface of FIG. 2 in greater detail of the audio data acquired using the one or more machine-learning models of FIG. 5. The audio generation system 116 provides a PbD authoring framework that supports direct interaction, e.g., as part of an XR experience. User interactions, for instance, are detected with an XR scene as performing actions involving movement of virtual objects, interacting with the real-world surfaces, and so forth. When an event is detected, a text label 602 appears and candidate items of audio data are acquired for the detected events.

In the illustrated example, a virtual object 604 portrays a car as disposed on a depiction 606 of a physical object captured of a physical environment, e.g., using a digital camera, previously as a saved video, and so forth. The illustrated user interface 128 includes a overlay of representations of events, text describing the events (e.g., based on the prompt 212), and representations of options that are user selectable to consume the options for selection as part of generating digital content that includes the audio data 122.

User inputs, for instance, may be received that “click on” a sound effect to preview it and double click to select and activate it during the XR session. After confirming the choices, the authoring panel may be hidden to resume the XR experience and test the selected audio data and then access the editing interface to modify the digital content.

In an implementation, the illustrated user interface 128 also supports an input (e.g., a “long press”) associated with the option to surface a menu with a suite of exploratory options. For recommended or retrieved items of audio data, the menu includes an option to list other sound assets in a threshold number of recommendations. The menu is also configurable to support a “style transfer” and “generate similar sounds” feature, enabling style transfer audio effects or to generate similar sounds based on the selected sound. When this feature is selected, a simple text prompt is received via the illustrated user interface 128 to guide the sound generation process. This feature enables iterative refinement of sound effects and to explore sound variations.

The audio data 220 as generated by the audio generation system 116, automatically and without user intervention, is usable in support of a variety of usage scenarios. An audio augmented reality scenario, for instance, may leverage the audio data 220 for accessibility assistance for blind or low vision (BLV) people. By generating the audio data 220 based on real world environments and virtual contents, for instance, BLV people can better interpret visual information in both reality and virtuality. Accordingly, the audio generation system 116 is configured to assist on accessibility in XR experiences in three ways. First, by supporting XR sound authoring, the audio generation system 116 encourages creators to add sound effects in XR experiences, which can help BLV users consume visual contents. Second, by providing context-aware XR sound in three-dimensional audio, users with low-vision can better navigate virtual objects in an XR environment. Third, by enabling user interaction with real-world surfaces via XR (e.g., tapping on a real-world surface), users can explore the surrounding space via the XR interface. For example, by authoring different bouncing sound effects for different surfaces (e.g. wood and carpet), a user can better perceive the location of an object that is interacting with those surfaces.

The audio generation system 116 also supports extensibility with existing XR applications as integrated as an extension. If implemented at a software development kit (SDK) level, the audio generation system 116 is configurable to automatically capture textual description of XR events and provide audio data generation using the automatic sound acquisition results. A variety of other examples are also contemplated.

Accordingly, content aware audio data generation techniques are described above address a variety of technical challenges. The audio generation system 116, for instance, is configurable to employ a large language model (LLM) based audio authoring system. The audio generation system is configured to acquire audio data, automatically and without user intervention, based on a context that is monitored for an interaction that is to serve as a basis for generating the audio data, e.g., as a sound effect. The audio generation system, in one or more examples, is configurable to implement a programming by demonstration (PbD) pipeline to automatically collect a context as contextual information of an event, which may include virtual content semantics, real world context, and so forth. Data detailing this context is then processed by a large language model to acquire audio data.

### Example System and Device

FIG. 8 illustrates an example system generally at 800 that includes an example computing device 802 that is representative of one or more computing systems and/or devices that implement the various techniques described herein. This is illustrated through inclusion of the audio generation system 116. The computing device 802 is configurable, for example, as a server of a service provider, a device associated with a client (e.g., a client device), an on-chip system, and/or any other suitable computing device or computing system.

The example computing device 802 as illustrated includes a processing device 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812 that stores instructions that are executable to cause the processing device 804 to perform operations. The computer-readable storage medium is configured for storing instructions that, responsive to execution by the processing device, causes the processing device to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In implementations, the platform 816 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
detecting, by a processing device, an event from one or more inputs defining interaction of a virtual object in a user interface with a depiction of a real-world physical environment captured by frames of a digital video;
monitoring, by the processing device, a context of the event in the user interface;
generating, by the processing device, a prompt to initiate acquisition of audio data based on the context using one or more machine-learning models; and
presenting, by the processing device, the audio data acquired by the one or more machine-learning models for output via the user interface.

2. The method as described in claim 1, wherein the frames of the digital video are captured by a digital camera of a computing device that includes the processing device and presenting is performed in the user interface as the frames are received using an audio output device.

3. The method as described in claim 1, wherein the context defines an event type and a subject of the event.

4. The method as described in claim 3, wherein the event type is:
a tap on a real-world object depicted in the real-world physical environment of the user interface;
a tap on the virtual object depicted in the user interface;
movement of the virtual object on a surface;
a collision between the virtual object and another object;
an animation of the virtual object; or
appearance of the virtual object in the user interface.

5. The method as described in claim 1, wherein the prompt is configured solely using text as describing the context and the virtual object.

6. The method as described in claim 1, wherein the generating of the prompt is performed by filling out a template based on the context and the virtual object.

7. The method as described in claim 1, wherein the one or more machine-learning models are configured to acquire the audio data using local recommendation, online retrieval, audio generation using an audio diffusion model, or audio transfer using text-based sound style transfer.

8. The method as described in claim 1, wherein the presenting includes presenting representations of a plurality of options of the audio data in the user interface that support user selection for output in the user interface in conjunction with the event.

9. The method as described in claim 8, wherein the representations include textual descriptions of audio sources associated with respective said options.

10. The method as described in claim 1, wherein the presenting includes presenting a collision warning of the virtual object with a depiction of a real-world object of the real-world physical environment in the user interface.

11. A computing device comprising:
a processing device; and
a computer-readable storage medium storing instructions that, responsive to execution by the processing device, causes the processing device to perform operations including:
detecting an event from one or more inputs, the event involving interaction of a subject with an object in a user interface;
monitoring a context of the event in the user interface;
generating a prompt to initiate acquisition of audio data based on the context using generative artificial intelligence (AI) as implemented using one or more machine-learning models; and
presenting the audio data acquired by the one or more machine-learning models for output via the user interface.

12. The computing device as described in claim 11, wherein the user interface includes a depiction of a real-world physical environment.

13. The computing device as described in claim 11, wherein the input describes movement of the subject in relation to the object, the movement indicated through a user input as received via the user interface, and the presenting is performed in real time as the input is received describing the movement.

14. The computing device as described in claim 11, wherein the subject is a virtual object and the object is captured of a real-world object in one or more frames of a digital video.

15. The computing device as described in claim 11, wherein the object is a virtual object and the subject is captured of a real-world object in one or more frames of a digital video.

16. The computing device as described in claim 11, wherein the one or more machine-learning models are configured to acquire the audio data using local recommendation, online retrieval, audio generation using an audio diffusion model, or audio transfer using text-based sound style transfer.

17. One or more computer-readable storage media storing instructions that, responsive to execution by a processing device, causes the processing device to perform operations comprising:
initiating audio data acquisition based on a context of an event using generative artificial intelligence (AI) as implemented using one or more machine-learning models, the event involving interaction of a virtual object in a user interface with a depiction of a real-world physical environment captured by frames of a digital video; and
presenting representations of a plurality of options of the audio data for display in a user interface that support user selection for output as part of the event.

18. The one or more computer-readable storage media as described in claim 17, wherein the representations include textual descriptions of audio sources associated with respective said options.

19. The one or more computer-readable storage media as described in claim 17, wherein the operations further comprise generating digital content including a selected option from the plurality of options of audio data.

20. The one or more computer-readable storage media as described in claim 19, wherein the digital content includes the frames of the digital video and the virtual object.
